(19) United States
(12) Patent Application Publication
(10) Pub. No.: US 2024/0108987 A1
(43) Pub. Date: Apr. 4, 2024

(54) OMNICHANNEL TRANSACTIONAL GAMES.

(71) Applicant: Sherry Carani, Charleston, SC (US)

(72) Inventor: Sherry Carani, Charleston, SC (US)

(21) Appl. No.: 17/959,298

(22) Filed: Oct. 4, 2022

(51) Int. Cl. A63F 13/63; A63F 13/73

(52) U.S. Cl. CPC A63F 13/63; A63F 13/73; A63F 2300/575

(57) ABSTRACT

A distributed network system and computer-implemented method for omni-channel transactional games, which enable external users such as a sender to institute transactions from cross platforms and omnichannels that are augmented directly into game play and may contain rich digital content, monetary and other unit(s) of contribution of value to the external user's targeted in-game recipient(s). The contributions may be collected by the intended in-game recipient(s) and shared and/or redeemed instantly for online purchases for tangible items and/or enabling in-game microtransactions. A key component is the digital game augmentation framework (DGAF) when applied to a digital game turns the game into hybrid “transactional game” that becomes a delivery system for external user's rich digital content, cash, and valuables. Each time an external user selects a game to send to a recipient, a new transactional game instance is spawned.

This application claims the benefit to U.S. Provisional Application No. 63/228,973, filed on Aug. 3, 2021, which application is incorporated herein by reference as if set forth in its entireties.

### FIELD OF THE INVENTION

The present invention relates generally to delivering rich user content and cash contribution transactions from and between external users and specific in-game players. Specifically, the invention relates to digital games, greetings, gifting, cash transactions and other valuable contributions.

### BACKGROUND OF THE INVENTION

We almost always know how much we want to spend on a gift, but we almost never know what to buy! The fact that we usually don't buy people their desired or useful items has created a huge gift card market, but both the original problem and its current gift card solution are fraught with poor entertainment value, fraud, economic and environmental problems. In short, buying a gift may be easy, but it is definitely not simple, and the fact that we usually don't buy people useful items has created a huge environmental problem. What is worse is that there is no end in sight. If we keep doing what we are doing, we are going to compound an already costly and unsustainable outcome. The only answer is for the greeting and gifting markets to evolve!

### SUMMARY OF THE INVENTION

Various embodiments provide an Omnichannel Transactional Games comprising a distributed network system for omni-channel transactional games comprising at least one (1) apparatus communicatively coupled to a plurality of omni-channel transactional engines, said omni-channel transactional engines communicatively coupled to at least one computing device said one computing device communicatively coupled to a corporate virtual network and sharing a common identifier to thereby facilitate data exchange between said apparatus and the at least one computing device thereby establishing a communication channel for information exchange;
a non-transitory computer readable medium having stored thereon instructions that, upon execution by the at least one computing device, cause the computing device to perform the steps comprising:
(a) accepting a request to exchange data propagated toward the at least one computing device;
(b) defining new mapping execution between the exchange apparatus;
(c) propagating toward said exchange apparatus parameters necessary to evaluate the acceptability of the data exchange; and
(d) receiving from said exchange apparatus parameters defining the type of the request;
wherein said system for omni-channel transactional games enables a sender to interact with an augmented digital game instance to personalize said game instance adding messages, contributions corresponding to a gift associated with a personal event, said gift intended for a recipient thereby rendering a transactional game to be available to the recipient.

Another embodiment provides a computer-implemented method for omni-channel transactional games comprising:
(a) acquiring an existing game;
(b) accepting a request to exchange data propagated toward at least one computing device;
(c) defining new mapping execution between an exchange apparatus and the at least one computing device;
(d) propagating toward said exchange apparatus parameters necessary to evaluate the acceptability of the data exchange; and
(e) receiving from said exchange apparatus parameters defining the type of the request;
wherein said method for omni-channel transactional games enables a sender to interact with an augmented digital game instance to personalize said game instance adding messages, contributions corresponding to a gift associated with a personal event, said gift intended for a recipient thereby rendering a transactional game to be available to the recipient.

### BRIEF DESCRIPTION OF THE DRAWINGS

The teachings of the present invention can be readily understood by considering the following detailed description in conjunction with the accompanying drawings, in which:

FIG. 1 depicts a high-level architecture of a system benefiting from embodiments of the present invention;

FIG. 2 depicts a high-level block diagram of a computing architecture (platforms, engines, frameworks and modules) benefiting from embodiments of the present invention;

FIG. 3 depicts a Flow Chart of a process for implementing the algorithm according to an embodiment of the invention;

FIG. 4 depicts an exemplary personalization Application Programming Interface (API) method benefiting from embodiments of the present invention;

FIG. 5 depicts an exemplary Block Diagram of Games Sent & Encrypted Key Links benefiting from embodiments of the present invention; and

FIG. 6 depicts an exemplary Block Diagram for Templatizing A Licensed Game And Adding the Digital Game Augmentation Framework (DGAF) Model benefiting from embodiments of the present invention.

To facilitate understanding, identical reference numerals have been used to designate elements having substantially the same or similar structure and/or substantially the same or similar function.

### DETAILED DESCRIPTION OF THE INVENTION

The present disclosure provides, inter alia, omni-channel transactional games or Digital Game Augmentation Framework (DGAF) thereof, wherein:

### Rich Content May Include:

Text—Digital Text can be found on the Internet or on your computer or on a variety of hand-held electronic devices.
Animations—Computer animation in games, shorts, ads, commercials, and videos. The animations may be dynamic or static, and may be two-dimensional (2D), or 3-D computer graphics used for creating characters, scenes and special effects in games, shorts, sales ads, commercials, and videos.
Images—a picture produced on an electronic display mobile device, computer screen and graphic representation.
Video—a program, movie, or other visual media product featuring moving images, with or without audio, that is recorded and saved digitally.
Augmented Reality (AR)—AR can be defined as a system that incorporates three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. In this way, augmented reality alters one's ongoing perception of a real-world environment, whereas virtual reality completely replaces the user's real-world environment with a simulated one.
Optical Effects—Special effects are traditionally divided into the categories of mechanical effects and optical effects. With the emergence of digital film-making and gaming, a distinction between special effects and visual effects has grown, with the latter referring to digital post-production and optical effects, while “special effects” refers to mechanical effects.
Avatars—In computing, an avatar is a graphical representation of a user or the user's character or persona. Avatars can be two-dimensional icons in Internet forums and other online communities, where they are also known as profile pictures, user pics (personal icons). Alternatively, an avatar can take the form of a three-dimensional model, as used in online worlds and digital video games.
Easter Eggs—Secret bits of media that developers hide inside video games or computer software are often referred to as Easter Eggs. They can come in the form of text or graphics and usually appear by surprise.

### Digital Games May Include:

WebGL Games—(Short for Web Graphics Library) is a JavaScript API for rendering interactive 2D and 3D graphics within any compatible web browser without the use of plug-ins. WebGL is fully integrated with other web standards, allowing GPU-accelerated usage of physics and image processing and effects as part of the web page canvas. WebGL elements can be mixed with other HTML elements and composited with other parts of the page or page background. WebGL programs consist of control code written in JavaScript and shader code that is written in OpenGL ES Shading Language (GLSL ES), a language similar to C or C++, and is executed on a computer's graphics processing unit (GPU).
Casual Games—A casual game is a video game targeted at a mass market audience, as opposed to a hardcore game, which is targeted at hobbyist gamers. Casual games may exhibit any type of gameplay and genre. They generally involve simpler rules, shorter sessions, and require less learned skill.^{[1]} They don't expect familiarity with a standard set of mechanics, controls, and tropes.
Hyper Casual Games—A hyper-casual game is a mobile video game which is easy-to-play, and usually free-to-play; they also feature very minimalistic user interfaces. These games can be quickly played after downloading, usually without any tutorial or instructions. They also often use a 2D design with a simple color scheme, easy mechanics adding to their simplicity. Usually featuring infinite looped mechanics, hyper-casual games are playable for an infinite amount of time, leading to their addictive nature. Some argue hyper-casuals are a business model, rather than a genre.
Web3 Games—Web3 gaming revolves around the principle that players should have full autonomy and ownership over their acquired assets, using blockchain technology such as non-fungible tokens (NFTs).
Online Games—An online game is a video game that is either partially or primarily played through the Internet or any other computer network available. Online games are ubiquitous on modern gaming platforms, including PCs, consoles and mobile devices, and span many genres, including first-person shooters, strategy games, and massively multiplayer online role-playing games
Mobile Games—A mobile game is a video game that is typically played on a mobile phone.^{[1]} The term also refers to all games that are played on any portable device, including from mobile phone (feature phone or smartphone), tablet, PDA to handheld game console, portable media player or graphing calculator, with and without network availability.
Streaming Games—Streaming is an alternative to file downloading, a process in which the end-user obtains the entire file for the content before watching or listening to it. Through streaming, an end-user can use their media player to start playing digital video or digital audio content before the entire file has been transmitted. The term “streaming media” can apply to media other than video and audio, such as live closed captioning, ticker tape, and real-time text, which are all considered “streaming text”. Streaming is most prevalent in video on demand and streaming television services. Other services stream music or video games.
Console Games—A console game is a type of video game consisting of images and often sounds generated by a video game console, which are displayed on a television or similar audio-video system, and that can be manipulated by a player. This manipulation usually takes place using a handheld device connected to the console, called a controller. The controller generally contains several buttons and directional controls such as analogue joysticks, each of which has been assigned a purpose for interacting with and controlling the images on the screen. The display, speakers, console, and controls of a console can also be incorporated into one small object known as a handheld game.
Multi-Player Games—A multiplayer game is a game of several players who may be independent opponents or teams. Games with many independent players are difficult to analyze formally using game theory as the players may form and switch coalitions.^{[19]} The term “game” in this context may mean either a true game played for entertainment or a competitive activity describable in principle by mathematical game theory.
Blockchain—NFT Games—A blockchain game (also known as a NFT game or a crypto game) is a video game that includes elements that use cryptography-based blockchain technologies. Blockchain elements in these games are most often based on the use of cryptocurrency or non-fungible tokens (NFTs) which players can buy, sell, or trade with other players, with the game publisher taking a fee from each transaction as a form of monetization. A subset of these games are also known as play-to-earn games because they include systems that allow players to earn cryptocurrency through gameplay.
Virtual Reality (VR) Games—Virtual reality is a simulated experience that can be similar to or completely different from the real world. Applications of virtual reality include entertainment (particularly to digital video games.) Currently, standard virtual reality systems use either virtual reality headsets or multi-projected environments to generate realistic images, sounds and other sensations that simulate a user's physical presence in a virtual environment.
AR Games—Augmented reality gaming (AR gaming) is the integration of game visual and audio content with the user's environment in real time. Unlike virtual reality gaming, which often requires a separate room or confined area to create an immersive environment, augmented reality gaming uses the existing environment and creates a playing field within it.
Money Hunt Games—Games that involve a search for tokens, treasures or cash can be exciting to play, especially when the players are rewarded for all that they accumulate during the course of the game.
Non-Fungible Tokens (NFT)—A non-fungible token (NFT) is a record on a blockchain which is associated with a particular digital or physical asset.^{[1]} The ownership of an NFT is recorded in the blockchain, and can be transferred by the owner, allowing NFTs to be sold and traded. NFTs can be created by anybody, and require few or no coding skills to create.^{[2]} NFTs typically contain references to digital files such as photos, videos, and audio. Because NFTs are uniquely identifiable assets, they differ from cryptocurrencies, which are fungible.
Hybrid Transactional Game—Any game that includes our Digital Game Augmentation Framework, whether licensed game source or in-house developed game source code.

### CRM-Customer Relationship Management

Customer Relationship Management (CRM) uses a combination of machine learning and artificial intelligence to spur additional sales by enhancing the customer experience and building relationships
Recommend games to the user that match their interests, historical usage and calendar events (i.e., birthdays, anniversaries and holidays).
Remind gift senders when it is time to send another gifted game, based on prior purchase history
Use relationship data to recommend digital gift games for upcoming holidays to potential gift senders to generate new sales
Remind gift recipients that they have money in their account that can be used to purchase tangible merchandise in the online store or add money to an existing balance if gifts are higher in price than the existing account balance
Remind registrants and guests that they can shop for tangible gifts or buy additional games for upcoming events (i.e., holidays, birthdays and anniversaries) for other individuals such as co-workers, family and friends.

### Omnichannels

Omnichannels enable us to bring in additional customers from numerous different outlets (i.e., online platforms, promotions, organizations and social media)
Games ordered through cross-platform channels would enable us to bring in new customers from online promotions, installations (such as trade show booths, cards at restaurants, purchases that lead to a free game), retail stores and social media.
Gift Senders: Gift Senders are individuals who register online using a web browser or mobile App and purchase a personalized digital game that can be sent with a cash gift to one or more Gift Recipients.
Gift Recipients: Third party Gift Senders can purchase online digital games that will be customized with personal greetings and messages suited for any occasion. The digital games are given as gifts to selected individuals known as Gift Recipients. The object of the digital game is to rack up bonus points and earn the gifted cash rewards so they can be redeemed or banked in order to accumulate additional funds.
Game Skin: After licensing a game from a developer, we import the game source code into our Game Augmentation Framework (DGAF) and modify the code to create a template that is void of some of the original advertising and graphic elements. The resulting template or “Skin” can be used to create a multitude of new games by simply adding new backgrounds, hidden assets, game graphics and scoreboards. For example, we could Skin a word puzzle game and spawn that into a variety of new word puzzle games that are laid out differently to offer a new gaming experience, scoring and outcome.

### Mechanics

Polyvalent Logic: A form of many-valued logic or probabilistic logic. Use the same logic in more than one instance.
Satellite Mechanics: The slight variations introduced through satellite mechanics provide those elements of novelty indispensable to constantly enhance the challenge, refresh the game experience and sustain players' motivation in playing the game.
   Monetary and Other Unit(s) of Contribution: Includes anything of value, included but not limited to:
Non Fungible Tokens (NFT's)
Fiat Money
Crypto Currency
Services (Define)
Tangible Gifts
Sponsor Value Adds—Coupons, BOGOs, Purchase with Purchase and etc.

### Transactional Games

A third party non-player can send someone a transactional game that includes currency, or other monetary units of contributions.
The recipient account inside allows the game recipient to redeem any amount of the cash gifts or other contributions received from gift sender(s.
Gamification: The strategic attempt to enhance systems, services, organizations, and activities by creating similar experiences to those experienced when playing games in order to motivate and engage users.

Game Acronyms
ARPG—Action Role Playing Game; You become a character in an action game.
F2P—Free To Play; You can access the basics of the game for free.
FPS—First Person Shooter; You are the character shooting and see from your view.
HOG—Hidden Objects Game; You find items hidden in a picture in this puzzle game subgenre.
RPG—Role Playing Game; You become a character to interact or collaborate with others.
RTS—Real Time Strategy; You accomplish goals in real time.
SIM—Simulation Games; You train in a simulated version of real life.
TBS—Turn-Based Strategy; Players take turns choosing actions.
TCG—Trading Card Game; You play a digital version of a card game.
TD—Tower Defense; You build towers to stop an enemy from reaching a certain place and/or defend your towers from enemy attack.
TMG—Time Management Game; You complete an increasing number of tasks in a set time limit.
TPS—Third Person Shooter; You control the shooter character you see on the screen.
MMO—Massively Multiplayer Online; Large number of players play together online in the same online world.
MMORPG—Massively Multiplayer Online Role Playing Game.
MOBA—Multiplayer Online Battle Arena; You control a character on one of two teams in this RTS subgenre.

### Reducing the Adverse Environmental and Economic Impact:

Environmental Impact: Whether it's the holidays, or a graduation, a birthday or a retirement we are expected to offer greetings with a gift, so we do it. This sort of unemotional, almost apathetic behavior has resulted in some ugly truths and a variety of measurable downside impacts to our traditional greeting and gifting activities. For example, according to Optoro®, an optimization platform that helps companies manage returned inventory, a shocking $380 billion in merchandise is returned to retailers each year, as people attempt to exchange UNWANTED GIFTS, or items that didn't suit them in some way. There are $90 billion in product returns at the holidays, alone! These figures do not even account for the unwanted gifts that are unused, re-gifted, end up in a yard sale, or are discarded, entirely. Why does this happen? Primarily, because we too often go the quick and easy route, grabbing impulse items as gifts. We rarely give the recipient an item that is spot-on, or perfectly in line with their needs or desires.

It is not Instore shopping vs online shopping impact in this case but starting with buying a desired gift as opposed to receiving one they totally do not want.

According to Optoro®, most consumers believe that returned goods are re-shelved (and resold), but the tragic truth is that billion of pounds worth of merchandise get diverted straight to landfills each year, with 5 billion pounds being dumped in 2020 alone. This behavior has left a staggering environmental impact in its wake. It is equal to all of the trash created by five million Americans in a year.

How about Gift Cards? Would you be surprised to learn that more than $3 billion in Gift Cards goes unspent, each year? Cards get lost, misplaced or if they are not associated with a retailer we patronize, we simply toss them aside. Many are used once and then retain balances that are never redeemed. Were you also aware that most gift cards are made of PVC plastic, which is very difficult to recycle? The fact is that most recycling systems won't even accept gift cards because of the PVC. As a result, tens of billions of gift cards each year end up in the garbage and then on to landfills!

The impact of paper greeting cards. Well, the sad reality is that the entire life cycle of paper is damaging to the environment from beginning to end. This is certainly a major issue for all of us, however it has become an urgent, legitimate concern of millennials. It starts off with a tree being cut down and ends its life by being incinerated—emitting carbon dioxide into the atmosphere. The production of paper also uses an inordinate amount of water. To make matters even worse—the manufacturing process pollutes the ground and water with lignin, alcohol, cholates and chlorine, and the distribution of the cards leads to carbon dioxide emissions.

In September, CEO Jeff Bezos announced the company's commitment to fighting climate change, with the goal of reducing carbon emissions to be carbon-neutral by 2040. He said Amazon® would issue reports on its emissions regularly and set forth a timeline for the company to be run solely on renewables by 2030.

The disclosed embodiments further provide a digital game augmentation framework (DGAF), which may be built into a smart device, a smart watch, TV remote device, PC, smart bracelet, smart glasses or contact lenses.

Various embodiments provide a distributed network system and computer-implemented method for omni-channel transactional games, which enable external users such as a sender or third party to institute transactions from cross platforms and omnichannels that are augmented directly into game play and may contain rich digital content, monetary and other unit(s) of contribution of value to the external user's targeted in-game recipient(s). The contributions may be collected by the intended in-game recipient(s) and shared and/or redeemed instantly for online purchases for tangible items and/or enabling in-game microtransactions. A key component is the digital game augmentation framework (DGAF) when applied to a digital game turns the game into hybrid “transactional game” that becomes a delivery system for external user's rich digital content, cash, and valuables. Each time an external user selects a game to send to a recipient, a new transactional game instance is spawned.

The various embodiments offer an alternative to tired in-game advertising models, with a fresh idea that gamifies the “giving” markets and gives a gift giver and their recipient a new and exciting gift experience, replacing boring greeting cards and gift cards. The disclosed model of giving works for consumers, businesses, and impact organizations like charities and special causes.

The disclosed system is designed to provide a catalog of fun and entertaining money hunt games that are an innovative in-game delivery system for cash/crypto (money) gifts and personalized greetings for any holiday, event or occasion. The disclosed money hunt games are easy for senders to personalize and add gift money, and the disclosed system hides the gift money throughout the game like Easter Eggs for the recipients to find. At the end of the game, the gift money is added to the recipient's account wallet 114. The recipient can cash out, save the money, or spend it on the gift of their choice via shopping portal 121 or amazon associate product portal 109 or other affiliate product portals 110—this includes tangible hard goods and digital gifts available in our expansive online store 121. Gift money may also be spent by the recipient on entries to other types of games, including virtual, digital, console, NFT and blockchain. They can also spend the money on NFTs, cryptocurrencies or on microtransactions in other types of games. The recipient can choose to accumulate gift money in their secure wallet 114. All the accumulated amounts are stored for later purchases.

The disclosed browser-based platform allows users easy access online using computers, smartphones or tablets, and the web app 123 provides access from mobile stores (Android and IOS). Gift senders who visit the disclosed platform and wish to order are asked to register their account in our system. Their email and mobile number is verified, and if valid, an account and wallet are established. A Registered User can be both a Sender and a Recipient; their dual personas are controlled by unique ID's and are applied depending on which role they play within a game. Registered sender's can choose a game from the game catalog to “license” and add their money gift. After making payment, the gift sender can review an itemized receipt and they will be prompted to personalize a unique instance of the game for the recipient. The gift sender will be prompted to enter the game recipient's contact info and the system will verify that the recipient is an existing user and can proceed to the personalization phase. If the recipient is not found in the system, an account and wallet will be generated for the new user automatically. Once the recipient is verified the sender can add the recipient's event (occasion, holiday or just because). As an example, the game sender may be registered as Jane Doe. For the game selected, she can enter her nickname as “Auntie Jane”. A nickname can also be entered for the recipient (John Doe) as “Junior”. Using the sender and receiver nicknames, the greetings might say that Auntie Jane is sending the special gift game to Junior as a way of celebrating his birthday. The customization data may also be used to wish Junior a Happy Birthday in messages within the game as it is being played. A game in the catalog 120 is displayed by rich graphics showing a game thumbnail image, the game prices, description, video game trailer and other features deemed useful. The system demographic and interest filters will make it easy for senders of all skill levels to choose game(s) to purchase to deliver their gift(s). Game buyers will be asked to personalize the game. The game buyer will have an opportunity to preview the game details. At that time, a delivery date can be selected and a personal message can be added to the email/SMS recipient notification. In the recipient's message is a link that is used to access the game. This encrypted key link will ensure that the money hunt game is sent to the recipient with the personalized message on the event date designated by the sender once they complete the personalization process. All customized data is sent to the server via API and populates the targeted game instance. For specialized games such as NFT Blockchain games, we will send the data via a WebSocket API. An API/WebSocket API sends the data from the web entry form to the game database and server making it possible for our system to instantly drop all the entered details into the game. Our platform is designed to communicate data to all types of game engines including, but not limited to, online, mobile, console and virtual games.

Through the disclosed Multiple Contributor Module, external contributors can be invited by the sender to add money and message wishes to a targeted recipient's game instance via a contributor code sent to them by the sender or they can simply add it directly to the recipient's wallet. A recipient can add more money to their wallet as well.

A variety of different types of digital money hunt games can be selected from our web app or online catalog 120, including 2D, 3D, AR, VR digital and blockchain/NFT games. The original source code for thousands of digital games of all types and platforms can be readily licensed. The licensing fees and revenue sharing from these games provides valuable compensation that is highly desired by each of the game developers. Licensing of these games makes it possible for our DGAF to transform the existing games into many different hybrid transactional games. The new games may use the developer's original graphics, or we may replace them with new customized animations, graphics and assets within our DGAF. To the user, the resulting new game's appearance or story line may bear very little resemblance to the original game. The disclosed game development process makes it easy to modify the original source code to create templates so that we can “re-skin” the games, transforming them into a plethora of new games. The new games may function similarly to the original game, but the story, experience and theme can appeal to different demographics that satisfy a broader audience. For example, one original game template could spawn twenty (20) different new Role Playing Games (RPG) or money hunt games. Another game might be skinned into twenty (20) different word puzzle money hunt games. The resulting games will enable players to hunt for active objects or locations within the game that are delivered by our DGAF and when discovered, they activate and display personalized greetings and cash gifts.

Our proprietary algorithms automatically hide our active objects like distributed “easter eggs” throughout the game. Game players can visually track their accumulated points, bonus points and progress of accumulated money tokens and cash tally on the DGAF scoreboard.

The disclosed secure database collects all user information including game registration information, game selection choices, cash gift options, personalization, game recipient information, greetings occasions and game selections. This information is used to automatically create a unique game ID # on the fly so that the new game key (link) is ready to be sent via email, SMS and/or other notifications to game recipients. After a recipient activates one of the key links from a device and begins play, any other key links sent are automatically disabled. For example, if a recipient accesses the game via a key link in an MMS text message, any link to the same game that was sent to them via email, or web app or any other method will be disabled.

The sender receives notifications of the players acceptance of the key link and playing progress, and the sender receives a thank you when the game is complete and the cash gift has been released to the recipient's wallet. Stock messages will make it quick and easy to thank any gift sender.

The disclosed embodiments solve the problem of what to give as a gift when one is suddenly faced with an upcoming occasion and know how much one wants to spend, but just does not know what to give, what's appropriate or what the gift recipient truly wants for themselves. By adding a cash gift, the game recipient can redeem the cash towards all the available gifts through the disclosed online store. This method of giving gifts is a vast improvement over merely choosing something that the person doesn't want, will not use, or may not be able to exchange. It also avoids the problems associated with giving gift cards or cash cards that can be lost, are difficult to keep track of, or that may never be redeemed.

The disclosed system securely stores all the data needed to track the many known events, holidays, occasions, senders, recipients, games played, coupon codes, gift interests, hobbies and online store purchase history. This data is aggregated, making it possible to anticipate when it will be time to recommend future gift giving opportunities. If selected by the registrants, the disclosed system can notify the appropriate individuals of anticipated anniversary and birth dates, holidays and recipient interests ahead of any special occasion. The disclosed system uses internal machine learning that is further supported by external marketing artificial intelligence (AI) to enhance user experience and detailed metrics for our business purposes.

The disclosed Digital Game Framework Augmentation (DGAF) can be used to customize many different types of digital games for almost any occasion. For example, they could be modified for use by companies and given as gifts to employees as a thank you for a job well done. Commercial applications might include digital games that are embedded with promotional graphics and messages that would be gifted to third party recipients such as employees, clients, sponsors or customers. The resulting gifted games could ultimately be given to individuals, with the proceeds being gifted as donations to charities chosen by either the game player or gift sender. Variations of this same concept can be used to send a digital game that is embedded with customized messages and graphics for any type of event, occasion or promotion.

The illustrative digital game augmentation framework (DGAF) embodiments described herein are not meant to be limiting. It may be readily understood that certain aspects of the disclosed digital game augmentation framework (DGAF) can be arranged and combined in a variety of different configurations, all of which are contemplated herein.

Generally speaking, any computing device such as a cellular telephone or smart phone or any computing device having similar functionality may implement the various embodiments described herein. In various embodiments, any Internet enabled device such as personal digital assistant (PDA), laptop, desktop, electronic book, tablets and the like capable of accessing the Internet may implement the various embodiments described herein. While computing devices are generally discussed within the context of the description, the use of any device having similar functionality is considered to be within the scope of the present embodiments.

Visitors go to Tokkenz.com home page. The top menu bar contains a search feature to look for a specific game to purchase. If the user has an account, they can LOGIN in the top menu bar.

Below the slider images the user can see many Game Categories
Flying Games
Hidden Object Games
First-Person Shooter Games
Word Games
Side Runner Games
And more can be viewed by using the arrow key to navigate to additional Game Categories.

Below the Game Categories are visual graphics showing all the games. Each of the game prices are shown in a token at the top right corner of each of the shown games. After scrolling down further, you will see the additional games.

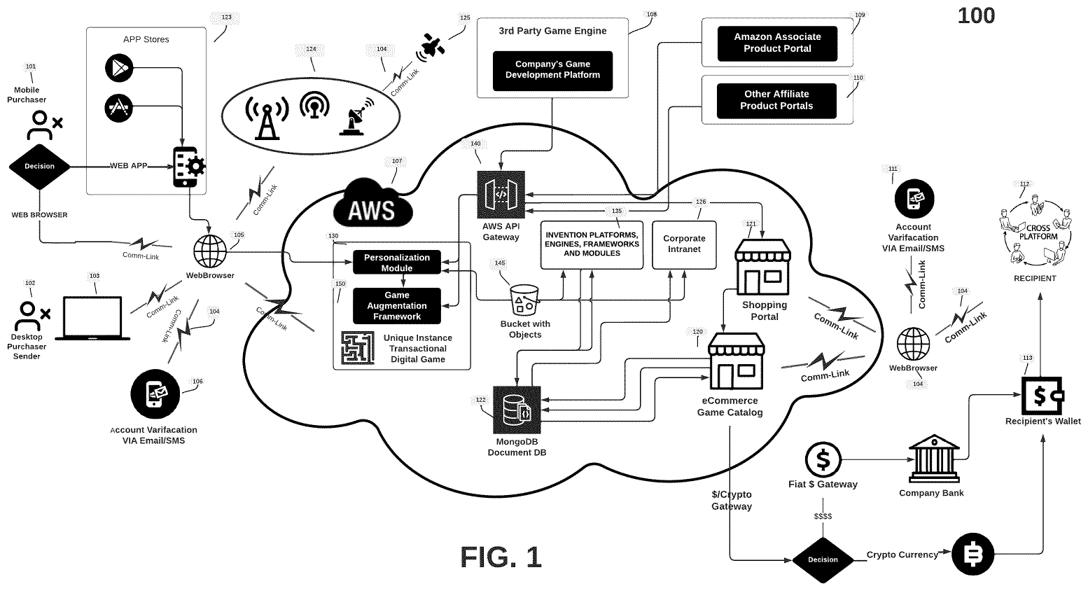

Referring now to the figures, FIG. 1 depicts a high-level architecture of a system 100 benefiting from embodiments of the present invention, according to an exemplary embodiment herein described.

In one embodiment, user 101 interacts with the browser-based platform through easy access online using computers, smartphones or tablets, and the web app provides access from mobile stores (Android and IOS 123) via link 104 and WebBrowser 105. In one embodiment, link 104 extends over great distance and is a cable, satellite 125 or fiber optic link, the Internet, the Cloud 107, a combination of such links or any other suitable communications path. In various embodiments, link 104 extends over a short distance. In one embodiment, link 104 is a network connection between geographically distributed systems, including network connection over the Internet. In other embodiments, link 104 is wireless 124, an access network 120, 121, a virtual private network 126.

In various embodiments, desktop purchaser sender 102 uses device 103, user as a recipient 112 uses device 113, which is a smart phone, cellular telephone, personal digital assistant (PDA), wireless hotspot or any Internet-enabled device including a desktop computer, laptop computer, tablet computer, smart watch, smart remote control, smart credit card, IoT (Internet of Things) sensor, IoMT (Internet of Medical Things) sensor) and the like capable of accessing the Internet may be used for device 103.

In various embodiments, Satellite 125 is a geo-synchronous satellite system such as global positioning system (GPS). In one embodiment, satellite 125 is low earth orbit satellite system. In other embodiments, the use of any system having similar functionality is considered to be within the scope of the present embodiments.

In various embodiments, cellular system 124 is a wireless infrastructure supporting cellular network functionality. In one embodiment, cellular system 124 is a small area wireless system. In other embodiments, cellular system 124 is a wide area wireless system. In other embodiments, cellular system 124 is a Wi-Fi system. In various embodiments, cellular system 124 supports mobile services within an LTE (Long Term Evolution) network or portions thereof, those skilled in the art and informed by the teachings herein will realize that the various embodiments are also applicable to wireless resources associated with other types of wireless networks (e.g., 5G networks, 4G networks, 3G networks, 2G networks, WiMAX, CDMA, GSM, etc.), wireline networks or combinations of wireless and wireline networks. Thus, the network elements, links, connectors, sites and other objects representing mobile services may identify network elements associated with other types of wireless and wireline networks. In other embodiments, the use of any wireless system having similar functionality is considered to be within the scope of the present embodiments.

In various embodiments, Engine 130 contains a personalization module, which implements the following functions
Automated Game Custom Cover Personalization;
User and Recipient Names Automated into Messages and Greetings;
Profile Image and Other Rich Content Automated into Messages and Greetings;
Content Packages Stock Greeting Packages and/or User Greetings;
Event Images—Stock Images and/or User Images;
Recipient Verification;
Automated Account and Wallet set up.

In various embodiments, bucket with objects 145 contains active objects like distributed “easter eggs” throughout the game. In one embodiment, active objects comprise both bonus points and hot assets the value of each is proportional to the value accumulated. In other embodiment, active objects comprise one type of either bonus point or hot asset.

In various embodiments, AWS API Gateway 140 instantiates an API/WebSocket API that sends the data from the web entry form to the game database and server making it possible for the disclosed system to instantly drop all the entered details into the game. The disclosed platform is designed to communicate data to all types of game engines including, but not limited to, online, mobile, console and virtual games. In the recipient's message is a link that is used to access the game. This encrypted key link will ensure that the money hunt game is sent to the recipient with the personalized message on the event date designated by the sender once they complete the personalization process. All customized data is sent to the server via API and populates the targeted game instance. For specialized games such as Non-Fungible Token (NFT) Blockchain games, data is sent via a WebSocket API.

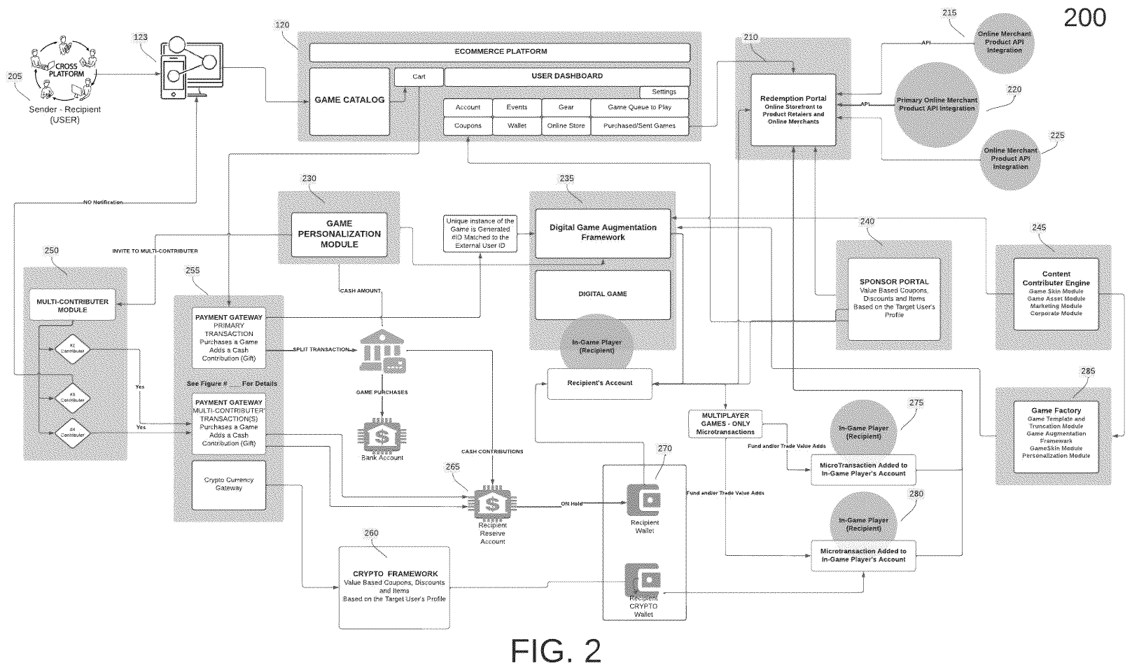

Invention Platforms, Engines, Frameworks and Modules 135 is discussed in reference to FIG. 2

In various embodiments, network 126 is an access network. In one embodiment, network 126 is a virtual private network (VPN). In other embodiments, network 126 is any network having similar functionality and as such is considered to be within the scope of the present embodiments.

Backend infrastructure 108 generally refers to infrastructure associated with the server or host, a web server, company's game development platform. Platform 108 is designed to communicate data to all types of game engines including, but not limited to, online, mobile, console and virtual games. MongoDB Document DB 122 securely stores all the data needed to track the many known events, holidays, occasions, senders, recipients, games played, coupon codes, gift interests, hobbies and online store purchase history. This data is aggregated, making it possible to anticipate when it will be time to recommend future gift giving opportunities. If selected by the registrants, our system can notify the appropriate individuals of anticipated anniversary and birth dates, holidays and recipient interests ahead of any special occasion. The system uses internal machine learning that is further supported by external marketing artificial intelligence to enhance user experience and detailed metrics for our business purposes. Our secure database 122 collects all user information including game registration information, game selection choices, cash gift options, personalization 130, game recipient information, greetings occasions and game selections. This information is used to automatically create a unique game ID # on the fly so that the new game key (link) is ready to be sent via email, SMS and/or other notifications to game recipients. After a recipient activates one of the key links from a device and begins play, any other key links sent are automatically disabled. For example, if a recipient accesses the game via a key link in an MMS text message, any link to the same game that was sent to them via email, or web app or any other method will be disabled.

In other embodiments, networking system 100 include additional, fewer, or different modules for various applications. Conventional components such as network interfaces, security functions, load balancers, failover servers, management and network operations consoles, and the like are not shown for better explanation of the details of the omni-channel transactional games.

Web hosting provider 105 refers to the universe of hosting services, e.g., smaller hosting services, larger hosting services and host management.

Saas (Software as a service), PaaS (Platform as a service) or IaaS (Infrastructure as a service) provider 107 refers to cloud services, hosting and the like.

FIG. 2 depicts a high-level block diagram of a computing architecture (platforms, engines, frameworks and modules) benefiting from embodiments of the present invention.

In various embodiments, sender 205 is the typical sender 101, 102, redemption portal 210 is the engine that enables access to online storefront to product retailers and online merchants 109, 110. Redemption portal 210 interfaces to APIs 215, 220, 225. Redemption portal also interfaces to sponsor portal 240 and In Game Player 280. In other embodiments, Redemption portal 210 interfaces to other APIs and engines.

In various embodiments, APIs 215, 220, 225 are Online Merchant product API Integration, Primary Online Merchant Product API Integration and Online Merchant Product API Integration respectively.

Game Personalization Module 230 is described in reference to 130.

Digital Game Augmentation Framework (DGAF) 235 when applied to a digital game turns the game into a hybrid transactional game. Each time an external user 101, 102 selects a game to send to a recipient 112, a new transactional game instance is spawned. Licensing of these games makes it possible for the disclosed DGAF to transform the existing games into many different hybrid transactional games. In some embodiment, the new games use the developer's original graphics, In other embodiments, we replace the developer's original graphics with new customized animations, graphics and assets within DGAF 235. To the user, the resulting new game's appearance or story line may bear very little resemblance to the original game. The disclosed game development process makes it easy to modify the original source code to create templates so that we can “re-skin” the games, transforming them into a plethora of new games. The new games may function similarly to the original game, but the story, experience and theme can appeal to different demographics that satisfy a broader audience. For example, one original game template could spawn twenty (20) different new Role Playing Games (RPG) or money hunt games. Another game might be skinned into twenty (20) different word puzzle money hunt games. The resulting games will enable players to hunt for active objects or locations within the game that are delivered by DGAF 235 and when discovered, they activate and display personalized greetings and cash gifts. Our proprietary algorithms automatically hide our active objects like distributed “easter eggs” throughout the game. Game players can visually track their accumulated points, bonus points and progress of accumulated money tokens and cash tally on the DGAF scoreboard. One embodiment of DGAF 235 is shown below.

Other embodiments of DGAF 235 are illustrated below namely, (1) Method of Displaying Personalized Message/Greeting and User; (2) Active (Hot) Assets and Bonus Points by Game Type; (3) 2D/3D RPG/FPG RANDOM ASSET MODULE; and (4) 2D/3D Grid & Landscape Variations.

1) Method of Displaying Personalized Message/Greeting and User
2 Active (Hot) Assets and Bonus Points By Game Type
3. 2D/3D RPG/FPG RANDOM ASSET MODULE
4. 2D/3D Grid & Landscape Variations

In various embodiments, sponsor portal 240 comprises Targeted Value Contribution Augmentation engine. In one embodiment, this engine implements a functionality of value based coupons, discounts and items based on the target user's profile. In another embodiment, the functionality incorporates promo codes, BOGOs, and gift with purchase. In yet another embodiment, Machine Learning and AI for user demographic and interest to match sponsor value ads are used.

In various embodiments, Content Contributor Engine 245 comprises Game Skin Module, Game Asset Module, Marketing Module e and Corporate Module. The Edit game interface is shown below.

### Game Inventory:

Game Name—Above game is called JetPack Defender
Game Type—Above game type is a 2D Flying Game
Registered User Price—Can be selected as the pricing for “Registered Users”
Subscriber Price—Pricing can be customized for “Subscribers”
Game Template—Select skinned game template for the chosen game
Server URL—shows the game location on the server
Registered User Special—Optional special that can be set up for Registered Users
Subscriber Special—Optional special that can be set up for Subscribers
Description—Text can be entered that will be used to describe the game
Game Category—Optional placement of game under an individual category
Info Tags—Tags can be used to assist in game searches and help users find games that appeal to their interests.
Game thumbnail—Upload thumbnail image to be displayed online for this specific game
Game Logo—Upload logo that will be used with the associated game
Teaser Video—Short trailer that will provide a short descriptive view of the game
   Game Category Tags

### Main Greeting Package

Used by Senders to send a group of greetings, by adding their name to the associated games, images and animation.

Greeting Category Tags

Every event has an associated greeting package and rich graphics content (images) that represent the occasions.

Event Categories
Event Subcategories

In various embodiments, Multi-Contributor Module 250 interfaces with Game Personalization Module 230 and module 123. The outputs of 250 feed into Payment Gateway 255. Multi-Contributor Module 250 allows a plurality of contributors to interface system 200. In the disclosed embodiment only three (3) contributors are shown. A signal or feed back is sent back to module 123 indicating “no notification” from contributor #2. It could have been any of the other contributors. In other embodiments, any number of contributors can access the system.

In various embodiments, Payment Gateway 255 comprises (1) Primary Transaction Module; (2) Multi-Contributor Transaction Module; and (3) Crypto Currency Gateway. Primary Transaction Module is used when a game is purchased, cash is added and contribution is made. Multi-Contributor Transaction Module is also used when a game is purchased, cash is added and contribution is made in the context of multi-contributors as the name implies. In other embodiments, other form of payment modules are added. Crypto Currency Gateway Module interfaces to Crypto Framework 260. Payment Gateway 255 interfaces with (1) Multi-Contributor Module 250; and (2) Ecommerce Platform 120. Payment Gateway 255 output is propagated toward: (1) DGAF 235 via a unique instance of the game, which is generated wherein the #ID is matched to the external user ID; (2) Game Purchases Bank Account; (3) Recipient Reserve Account (cash contributions); and (4) Crypto Framework 260.

In various embodiments and as previously described, Crypto Framework 260 administers value based coupons, discounts and items based on the target user's profile.

In various embodiments, Recipient Reserve Account 265 contains all forms of cash contributions including fiat currency, NFT, Bitcoins and the like. Recipient Reserve Account 265 propagates its “on hold” output toward module 270, which houses Recipient Wallet 114 and Recipient Crypto Wallet, which interface with In-Game Player 280.

In various embodiments, In-Game Player 275 and 280 perform complementary functions. In-Game Player 275 interfaces with DGAF via Multi Player Games Only whereas In-Game Player 280 interfaces with DGAF 235 and 270 in addition. In essence microtransaction is added to In-game Player's account using 275 and 280. In other embodiments, other configurations are possible.

In various embodiments, Game Factory 285 comprises: (1) Game Template and Truncation Module process makes it easy to modify the original source code to create templates so that we can “re-skin” the games, transforming them into a plethora of new games. The new games may function similarly to the original game, but the story, experience and theme can appeal to different demographics that satisfy a broader audience. For example, one original game template could spawn twenty (20) different new Role Playing Games (RPG) or money hunt games. Another game might be skinned into twenty (20) different word puzzle money hunt games; (2) DGAF 235; (3) Game Skin Module 615; and (4) Personalization Module 405.

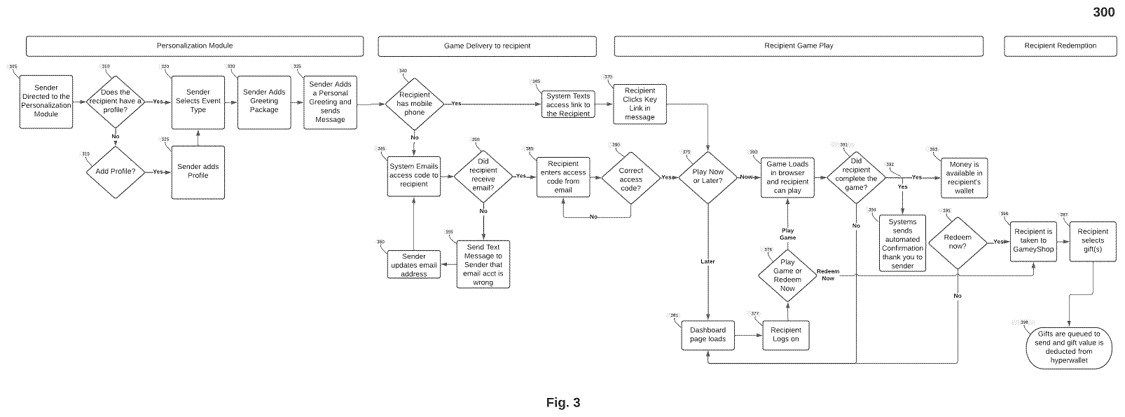

FIG. 3 depicts a Flow Chart of a process for implementing the algorithm according to an embodiment of the invention.

At step 305, sender 101, 102 is directed to personalization module 230. At step 310, a decision is made to determine if the recipient has a profile. If yes, step 320 is executed. If no, step 315 is executed where another decision is made to ascertain that the profile was added. If no, step 305 is re-executed. If yes, step 325 is executed where sender 101, 102 is directed to add a profile. At step 320, sender 101, 102 selects an event type. In one embodiment, an event type is personal such as birthday, graduation, wedding. In other embodiment, event type is general such as holiday or any other occasion. In yet other embodiment, an event type is characterized as a future event personal or general. At step 330, sender 101, 102 is directed to add greeting package. In one embodiment, a greeting is shown below.

In another embodiment, as illustrated above (module 235) rich content interactive greeting package can be added. Rich content can be in 2D, 3D, Augmented Reality (AR) and Virtual Reality (AR). In one embodiment, rich content contains images, animations, sound effects, avatars, music and sender greetings. In other embodiments, rich content contains fewer components.

At step 335, sender 101, 102 adds a personal greeting as shown above and sends the message. At step 340, it is determined if recipient 112 has a mobile phone (smart device). If yes, step 365 is executed and an access link is sent to the user via text message compatible with recipient's mobile phone. At step 370, recipient 112 activates key link in message and step 375 is executed. If no, at step 345 the system emails access code to the recipient. At step 350, a decision is made to determine if the recipient received the email. If no, a text message is sent to recipient alerting sender 101, 102 that recipient's email is incorrect. At step 360, sender 101, 102 updates recipient's email address. Step 345 is re-executed. If yes (step 350), recipient 112 enters access code from the email. At step 380, if the access code is incorrect step 375 is re-executed. If the access code entered is correct step 375 is executed. If recipient decides to play now, step 390 is executed. The game loads in the browser and recipient can play. At step 391, if the recipient completed the game steps 393 and 394 are executed. At step 393, money is deposited in recipient's wallet. At step 394, the system sends an automated confirmation thank you to sender 101, 102. At step 375, if recipient decides to play later step 381 is executed wherein the dashboard page is loaded. At step 376, if recipient decides to play now, step 390 is executed as discussed above. If recipient decides to redeem now then step 396 is executed where recipient is directed to shopping portal 121. At step 397, recipient selects one or more gifts. At step 398, gifts are queued to send and the value of the gift is deducted from hyper wallet 114.

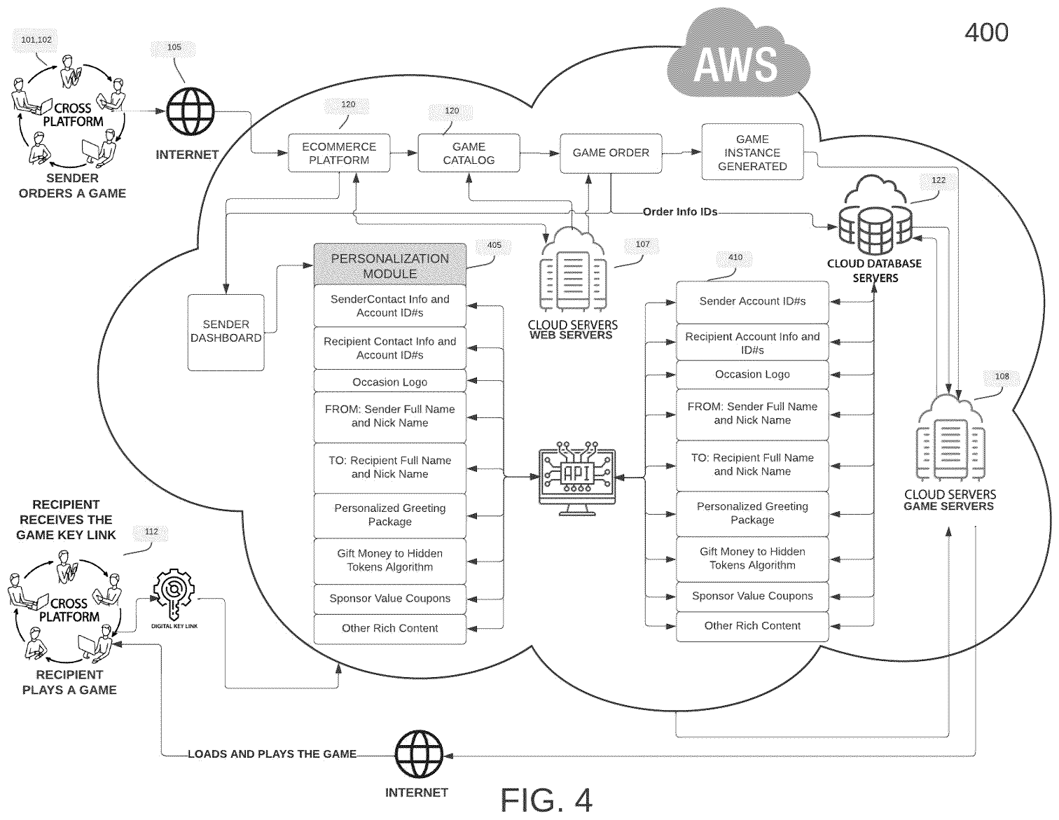

FIG. 4 depicts an exemplary personalization Application Programming Interface (API) method benefiting from embodiments of the present invention. In various embodiments, Personalization Module 405 interfaces with (1) Ecommerce Platform 120 and Game Order Module via sender dashboard; and (2) API. The interface with the API is an I/O interface. The following data are exchanged: (1) sender contact info and account ID #s; (2) Recipient Contact info and Account ID #s; (3) Occasion logo; (4) sender's full name and nick name; (5) recipient's full name and nick name; (6) personalized greeting package; (7) gift money to hidden tokens algorithm; (sponsor value coupons; and other rich content. In other embodiments, additional data is added.

In various embodiments, module 410 interfaces with API via an I/O interface and interfaces with cloud data base servers 122 via an I/O interface as well. The following data are exchanged: (1) sender account ID #s; (2) recipient's account info and ID #s; (3) Occasion logo; (4) sender full name and nick name; (5) recipient's full name and nick name; (6) personalized greeting package; (7) gift money to hidden tokens algorithm; (8) sponsor value coupons; and (9) other rich content. In other embodiments, additional data is added.

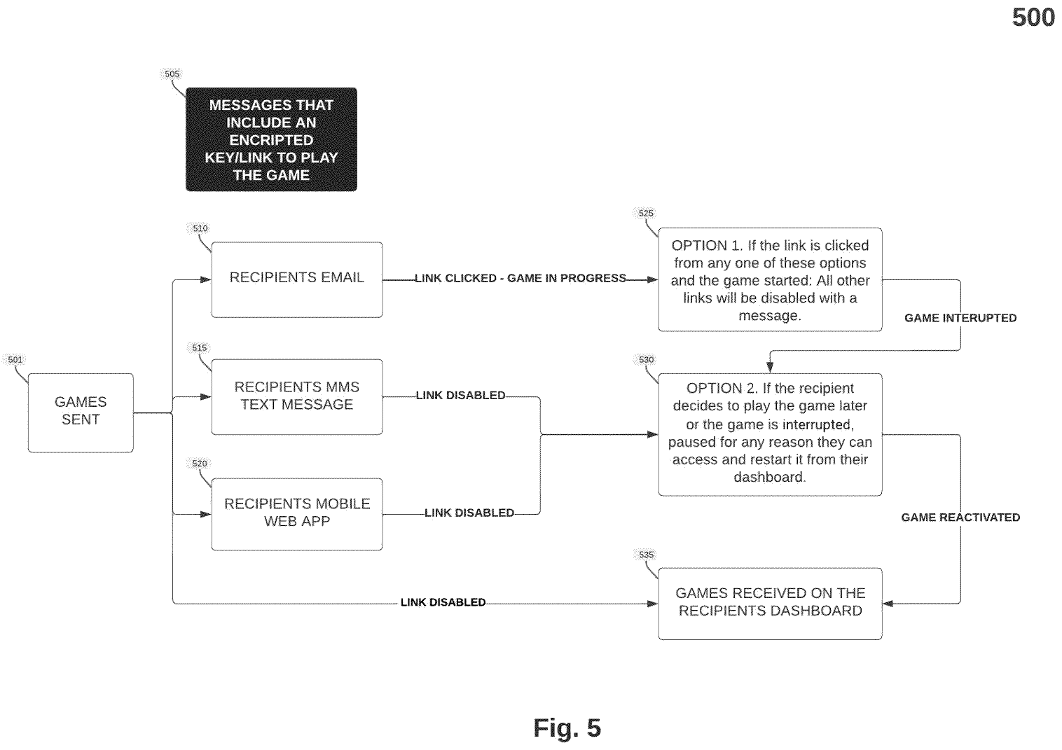

FIG. 5 depicts an exemplary Block Diagram of Games Sent & Encrypted Key Links 505 benefiting from embodiments of the present invention. At 501 games are sent. Links are disabled at 515 and 520. At 510, the link is in progress feeding into option 1 at 525. If the game is interrupted option 2 is executed (530). If the game is reactivated, step 535 is executed.

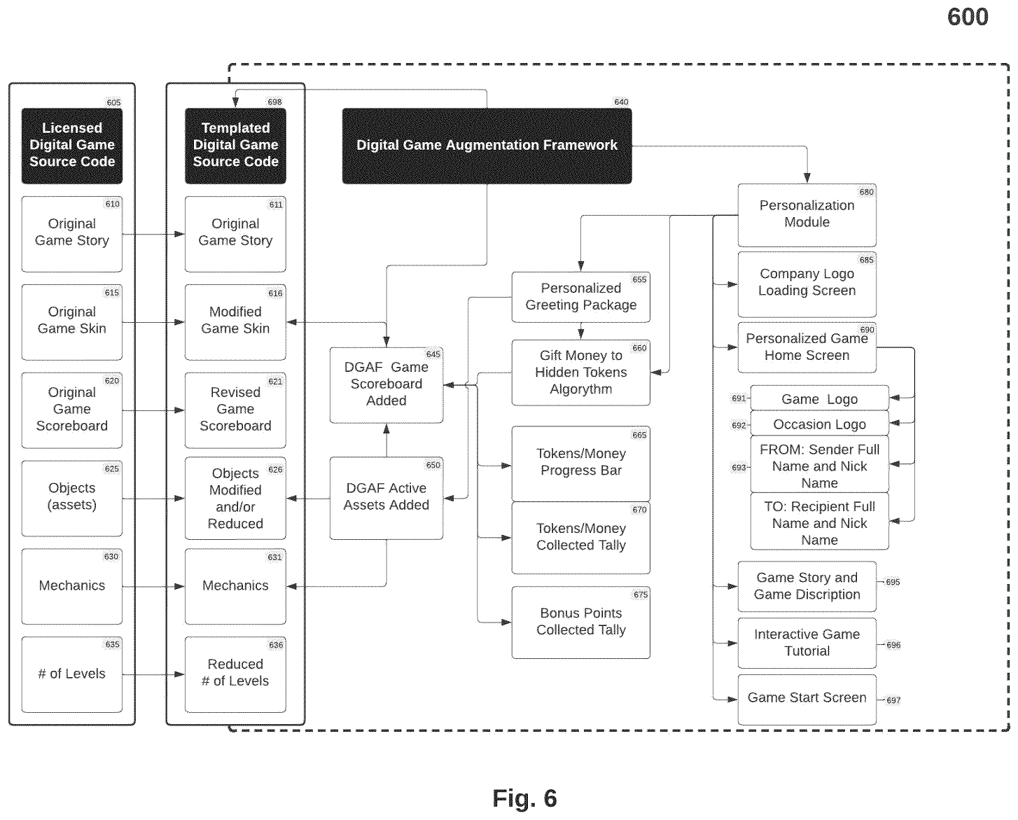

FIG. 6 depicts an exemplary Block Diagram for Templatizing A Licensed Game And Adding the Digital Game Augmentation Framework (DGAF) Model benefiting from embodiments of the present invention. This block diagram is self-explanatory. As illustrated, System 600 comprises three (3) modules namely, Licensed Digital Game Source Code 605, Templated Digital Game Source Code 698 and Digital Game Augmentation Framework 640.

Although depicted and described with respect to an embodiment in which each of the APIs, engines, databases, and tools is stored within memory, it will be appreciated by those skilled in the art that the APIs, engines, database, and/or tools may be stored in one or more other storage devices internal to computing device being used.

The APIs, engines and tools may be activated in any suitable manner. In one embodiment, for example, the APIs, engines and tools may be activated in response to manual requests initiated by a user, in response to automated requests initiated by computing device 105, or other devices and the like, as well as various combinations thereof. For example, where an engine or tool is activated automatically, the engine or tool may be activated in response to scheduled requests, in response to requests initiated by computing device 105 based on processing performed at computing device 105.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, in one mode of operation a menu of options is presented to the user to choose from. In such case, the execution of the steps is performed simultaneously or concurrently also known as multitasking. In one embodiment, parallel computing is used.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore, intended that the scope of the invention be limited not by this detailed description, but rather by any claims that issue on an application based hereon.

Although various embodiments, which incorporate the teachings of the present invention have been shown and described in detail herein, those skilled in the art can readily devise many other varied embodiments that still incorporate these teachings.

1. A distributed network system for omni-channel transactional games comprising:
at least one (1) apparatus communicatively coupled to a plurality of omni-channel transactional engines, said omni-channel transactional engines communicatively coupled to at least one computing device said one computing device communicatively coupled to a corporate virtual network and sharing a common identifier to thereby facilitate data exchange between said apparatus and the at least one computing device thereby establishing a communication channel for information exchange;
a non-transitory computer readable medium having stored thereon instructions that, upon execution by the at least one computing device, cause the computing device to perform the steps comprising:
(a) accepting a request to exchange data propagated toward the at least one computing device;
(b) defining new mapping execution between the exchange apparatus;
(c) propagating toward said exchange apparatus parameters necessary to evaluate the acceptability of the data exchange; and
(d) receiving from said exchange apparatus parameters defining the type of the request;
wherein said system for omni-channel transactional games enables a sender to interact with an augmented digital game instance to personalize said game instance adding messages, contributions corresponding to a gift associated with a personal event, said gift intended for a recipient thereby rendering a transactional game to be available to the recipient.

2. The system of claim 1, wherein said apparatus comprises a smart device, a console, a personal computer, a laptop, tablets, hand-held computers, wearable computers, supercomputers.

3. The system of claim 1, wherein said at least one computing device includes personal computers, desktops, laptops, tablets, hand-held computers, servers, workstations, mainframes, wearable computers and supercomputers.

4. The system of claim 1, wherein said communication channel is responsive based on user's apparatus and includes satellite, cellular, terrestrial, Internet, Cloud.

5. The system of claim 1, wherein said augmented digital game comprises: Block-chain game and said distributed network system includes Block-chain architecture.

6. The system of claim 1, wherein the sender interaction includes specifying custom messages, rich content, greetings, choosing graphics, avatar, personalizing the game, contributing fiat currency, crypto currency, non-fungible tokens (NFTs), playing in the game.

7. The system of claim 1, further comprising an augmentation framework engine, which adapts an existing game to the transactional game.

8. The system of claim 5, wherein the transactional game comprises: hot assets, random hot assets, fixed hot assets, 2-D mesh segments, 3-D landscape, 3-D terrain.

9. The system of claim 5, wherein hot assets further comprise bonus, rewards.

10. The system of claim 1, wherein the type of request comprises authentication, account validation, verifying and setting up new accounts, creating a game instance, redemption of points, contributions and gift shopping.

11. The system of claim 1, further comprising dividing a single gifted contribution and applying said single gifted contribution to one of: a designated number of hot assets, objects, fixed mesh/terrine segments.

12. The system of claim 1, wherein the at least one computing device further comprises:
a non-transitory computer readable medium having stored thereon instructions that, upon execution by the at least one computing device, cause the at least one computing device to perform functions comprising:
compiling one or more databases associated with one or more users including location coordinates of said users, wherein said one or more users are subdivided into sender, player, one or more recipients associated with a specific event and a plurality of players forming a group;
updating one or more corresponding databases as one or more new users join the group of players;
indexing one or more databases of default templates containing rich content, custom messages, greetings, choosing graphics, avatar, personalizing the game, contributing fiat currency, crypto currency, non-fungible tokens (NFTs);
rendering one or more custom templates containing background materiel and transitions selected by the sender;
determining a composite of default and custom templates selected by the sender to compose the transactional digital game; and
propagating towards the server, in response to a request a plurality of data points,
wherein the plurality of data points are associated with the transactional digital game.

13. A computer-implemented method for omni-channel transactional games comprising:
(a) acquiring an existing game;
(b) accepting a request to exchange data propagated toward at least one computing device;
(c) defining new mapping execution between an exchange apparatus and the at least one computing device;
(d) propagating toward said exchange apparatus parameters necessary to evaluate the acceptability of the data exchange; and
(e) receiving from said exchange apparatus parameters defining the type of the request;
wherein said method for omni-channel transactional games enables a sender to interact with an augmented digital game instance to personalize said game instance adding messages, contributions corresponding to a gift associated with a personal event, said gift intended for a recipient thereby rendering a transactional game to be available to the recipient.

14. The computer-implemented method of claim 11, further comprising the step of augmenting said game using a proper protocol to thereby adapt said game to a transactional game.

15. The computer-implemented method of claim 11, further comprising adding rich content to the game rather than device-to-device.

16. The computer-implemented method of claim 11, wherein the game facilitates delivery of the greeting.

17. The computer-implemented method of claim 1, wherein the sender interacts in the transactional digital game as a player.
